(19) United States
(12) Patent Application Publication
(10) Pub. No.: US 2013/0188511 A1
(43) Pub. Date: Jul. 25, 2013

(54) METHOD AND SYSTEM FOR CONTROLLING TRANSMISSION RATE OF DATAGRAMS IN A PACKET-SWITCHED NETWORK

(71) Applicants: Uri Avni, Tel Aviv (IL); Israel Drori, Newton, MA (US); Amit Meshbey, Modiin (IL)

(72) Inventors: Uri Avni, Tel Aviv (IL); Israel Drori, Newton, MA (US); Amit Meshbey, Modiin (IL)

(21) Appl. No.: 13/356,179

(22) Filed: Jan. 23, 2012

(51) Int. Cl. H04L 12/24; H04L 12/26

(52) U.S. Cl. 370/253

(57) ABSTRACT

A method and system are provided for maximizing reception rate of datagrams transmitted in a packet-switched network, by minimizing their transmission rate. The method comprises: forwarding datagram groups from a first location towards a second location, wherein each of the datagram groups includes a plurality of datagrams each comprising a first indication for identifying the group to which it belongs, wherein each group is forwarded at a different time than others, and wherein all datagrams that belong to a certain group are forwarded at substantially the same rate; at the second location, determining an arrival rate of datagrams which belong to a first group; based on the determined arrival rate, determining whether a change should be affected at the forwarding rate of a second group of datagrams; and if so, forwarding the second group of datagrams at the new rate.

### TECHNICAL FIELD

The present invention relates generally to data communication systems and, more particularly, to a method and a system for controlling packets' flow in a packet-switched communication network.

### BACKGROUND

One of the tools existing to control transmission rates along a packet-switched network is the use of buffers. Buffers are used in network devices to absorb traffic bursts. When the input traffic flow to the device is larger than the output flow, a queue builds up in the buffer. When the input flow is smaller than the output flow, the queue will drain. Therefore, the device can handle a variable input load that is larger than the device's output capacity for short periods of time. However, if the load mismatch lasts too long, the queue fills up and a passive manager starts dropping arriving packets that do not fit in the queue. This behavior has some major problems associated with it.

A first major problem is related to the way the Transmission Control Protocol (“TCP”) handles congestion avoidance. When experiencing a packet loss, TCP reduces its congestion window size, thus reducing the packet transmission rate. Once transmissions of individual packets are acknowledged, TCP increases the transmission rate again. During congestion, packets are dropped from multiple TCP flows, thereby causing multiple TCP flows to reduce their transmission rates at the same time. Once congestion conditions are relieved, the multiple TCP flows receive acknowledgments for their packet transmissions and increase their transmission rates at the same time. This phenomenon is called “TCP Global Synchronization” and results in bursty, “on-off” traffic that alternately causes congestion or network under utilization.

Another major problem associated with this mechanism is queuing delay. Under some conditions, queues get full or nearly full and stay that way for some time. This results in all packets experiencing a large delay, even if the traffic input rate does not exceed the output rate. Thus, waiting until a queue is full before dropping packets contributes negatively to queuing delay.

In addition the above problems also contribute to unfairness in the network. Passive queues result in bursty, high-bandwidth-consuming traffic. Such traffic is allowed to fill up the queue and once the queue is full, all incoming traffic is punished equally. This is especially harmful to smooth, low-bandwidth traffic that would otherwise not experience any packet loss.

More packets are dropped if the queue is full or nearly full because the size of available buffering to absorb traffic bursts is smaller. Most dropped packets have to be retransmitted, thereby reducing the throughput of useful traffic of the network. Under congestion, a single flow may encounter multiple sequential packet losses. The TCP algorithm does not recover well from such losses. Also TCP global synchronization can lead to buffer underflow and reduced throughput of useful traffic of the network.

In other words, although TCP protocol is a protocol designed to enable rate control and to prevent congestion, its performance particularly at high bitrates is inefficient as packets experience long round trip times and the mechanism is highly sensitive to packet loss. It should be noted that the TCP mechanism is also ill suited for timing sensitive data such as multimedia streams.

In a communication system, Quality of Service (hereinafter: “QoS”) refers to resource reservation and control mechanisms. QoS allows to provide different priorities to different applications, users, or data flows, or to guarantee a certain level of performance to a data flow. Some communication systems may use one or more of the following parameters for defining QoS: minimum sustained data rate, maximum sustained data rate, maximum tolerated delay or latency, maximum tolerated jitter, average Bit Error Rate (“BER”), average Packet Error Rate (“PER”), Traffic Priority, etc. QoS is especially important for real-time streaming of multimedia applications such as Voice over IP (“VoIP”), online gaming and Internet-TV, since these multimedia applications may often require certain guaranteed data rate, maximum tolerable delay, BER, etc.

The QoS parameter “delay” refers to the period of time taken by a packet to travel from its source to the destination. This period of time may include queuing period at different nodes along the route travelled by the packet in the communication network, processing time at different nodes, and the propagation time from the source to the destination. The amount of delay may depend on the congestion in the network, the route taken by the packet from the source to destination, and other factors. The QoS parameter “jitter” refers to the fluctuation in the time periods taken by different packets to reach the receiver. Delay and jitter may have a serious adverse affect upon the quality of media streaming.

Normally for different applications such as VoIP, multimedia streaming, email, file transfer, etc., the communication system may define different QoS levels. Real-time interactive applications such as VoIP are very sensitive to delay and jitter. Streaming applications such as watching a video clip over the Internet may be relatively less sensitive to delay than real-time interactive applications. Applications such as email and file transfers may not be particularly sensitive to delay and jitter. For many applications, the data rate requirement is one of the important parameters of QoS.

Other protocols have been developed in the attempt to solve some of the problems discussed above.

The Datagram Congestion Control Protocol (“DCCP”) is a message-oriented transport layer protocol. It implements reliable connection setup, teardown, congestion control, etc. and also provides a way to gain access to congestion control mechanisms without having to implement them at the application layer. It allows for flow-based semantics like in the TCP, but does not provide reliable in-order delivery. DCCP is useful for applications with timing constraints on the delivery of data. Such applications include streaming media, multiplayer online games and internet telephony. While being useful for these applications, DCCP may also be positioned as a general congestion control mechanism for UDP-based applications, by adding, as needed, a mechanism for reliable and/or in-order delivery on the top of UDP/DCCP.

As DCCP, the TCP Friendly Rate Control (TFRC) Protocol is also a protocol that is suitable for timing sensitive applications, and provide congestion control.

However, these last two protocols are even more sensitive to high roundtrip times and packet losses than the TCP protocol described above.

Furthermore, traditionally, methods for affecting rate control are driven by congestion detection, where speed is increased as long as congestion has not been detected. However, since congestion detection may quite often be a non-trivial task, especially in noisy and jittery networks, such an approach might lead to false detections, and still not to allow to fully unitize a link. Therefore, there is a need for a mechanism that will allow an efficient utilization of the packet-switched network resources at any bitrate, reduce delays in the arrival of the packets, and will provide a better rate control mechanism.

### SUMMARY OF THE DISCLOSURE

The disclosure may be summarized by referring to the appended claims.

It is an object of the present invention to provide a method and device for controlling transmission rate in datagram-based communication network.

It is another object of the present invention to enable efficient utilization of the network resources at any bitrate and be independent of the round-trip period and/or noise level.

It is still another object of the present invention to allow affecting tunable congestion control, thereby enabling the provisioning of different quality of service levels.

It is yet another object of the present invention to maximize reception rate of datagrams transmitted in a packet-switched network between first and second locations by enabling transmission of packets at a minimal packets' forwarding rate.

Other objects of the present invention will become apparent as the description of the invention proceeds.

According to a first embodiment, there is provided a method for controlling transmission rate of datagrams (i.e. packets) in a packet-switched network from a first location to a second location. The method provided, comprises the following steps:

forwarding a plurality of datagram groups from the first location towards the second location, wherein each of the datagram groups includes a plurality of datagrams that comprise a first indication to enable identifying the group to which a respective datagram belongs, wherein each of the plurality of groups is forwarded at a time different from the time at which all other groups are forwarded, and wherein each of the datagrams that belong to a certain group, is forwarded from the first location towards the second location at a rate which is substantially identical to the rate at which all other datagrams that belong to the same group will be forwarded from the first location towards the second location;

determining an arrival rate of datagrams which belong to a first group;

based on the determined arrival rate, determining whether a change should be affected at the rate at which datagrams that belong to a second group of datagrams will be forwarded towards the second location; and

if the determination is that a change should be affected at the forwarding rate of datagrams that belong to the second group of datagrams, forwarding the second group of datagrams at a rate different from the rate at which the first group of datagrams was forwarded from the first location.

The term “group” of datagrams/packets as used herein throughout the specification and claims, is used to denote a plurality of packets that are transmitted within a short period of time, e.g. a round of datagrams' transmission.

Preferably, the controlling of transmission rate of datagrams in a packet-switched network is done by enabling transmission of datagrams at a minimal datagrams' forwarding rate, thereby maximizing the reception rate of these datagrams.

In accordance with another embodiment, the step of determining whether a change should be affected at the forwarding rate of the second group of datagrams is based upon receiving at the first location a second indication which relates to the arrival rate of datagrams that belong to a certain group of datagrams. In addition, this second indication may include information that relates to the arrival of datagrams that belong to a number of groups, in which case the information comprised in the second indication will indicate the arrival rate of the datagrams per each one of these groups.

By yet another embodiment, the second indication is generated every pre-determined period of time.

According to another embodiment, the process described herein is repeated mutates mutandis for every group of datagrams, as long as all datagrams comprised in each respective group of datagrams include a first indication to enable identifying the group to which they belong.

By yet another embodiment, the determination on whether to affect a change in the forwarding rate is based upon a QoS level guaranteed for forwarding of datagrams from the first location to the second location. The QoS level may be for example associated with a percentage of datagrams that have timely arrived to the second location.

In accordance with yet another embodiment, the determination on whether to affect a change in the forwarding rate is made based upon whether the arrival rate of datagrams that belong to a certain group of datagrams, is lower than a threshold rate that was defined for that certain group of datagrams.

According to still another embodiment, the method provided further comprising a step of evaluating an actual error rate E_{R} associated with a certain group (e.g. group j) of datagrams that are received at the second location. The actual error rate (E_{R, j}) may be calculated for example based on the ratio between the forwarding and arrival rates, and/or based on missing sequence numbers as detected at the second location, and the like.

By yet another embodiment, if the error rate of group j (E_{R, j}) is higher than a maximum error rate (E_{R, MAX}) allowed according to the QoS defined for forwarding the datagrams of group j, the method comprises a step of decreasing the rate at which the proceeding group of datagrams will be forwarded from the first location, e.g. the forwarding rate of group j+1, so that the error rate (E_{R, j+1}) associated with the proceeding group (e.g. j+1 group) of datagrams arriving at the second location, would be equal to or less than the maximum allowable error rate (E_{R, MAX}) according to the QoS defined for forwarding these datagrams.

According to another embodiment, if the arrival rate of datagrams that belong to a certain group of datagrams (e.g. group j) that were forwarded from the first location at a forwarding rate F_{R, j} is equal to or higher than a threshold rate that was defined for that certain group of datagrams, the method further comprises a step of increasing the forwarding rate for a proceeding group (e.g. group j+1) and setting a new threshold for the arrival of the j+1 group to be equal to (1−E_{R, j})*F_{R}. As will be appreciated by those skilled in the art, if the datagrams of group j+1 experience congestion conditions along their route to the second location, the above new threshold may be further modified to compensate for such congestion conditions.

In accordance with still another embodiment, if the arrival rate of datagrams that belong to a certain group (j) of datagrams that were forwarded from the first location at a forwarding rate F_{R, j} is less than a threshold rate that was defined for that certain group of datagrams, or if the actual error rate of that group (E_{R, j}) is higher than the maximum error rate (E_{R, MAX}) allowed according to the QoS as defined for forwarding the datagrams of that group j, the method further comprises a step of decreasing slightly the forwarding rate for a proceeding group (e.g. group j+1) of datagrams.

In accordance with yet another embodiment, the datagrams are multimedia carrying datagrams, which may comprise video signals, audio signals and any combination thereof.

According to a second aspect, there is provided a system for controlling transmission rate of datagrams in a packet-switched network, wherein the system comprises:

at least one first transceiver configured to forward a plurality of datagram groups, wherein each of the datagram groups includes a plurality of datagrams that comprise a first indication to enable identifying the group to which a respective datagram belongs, wherein each of the plurality of groups is forwarded at a time different from the time at which all other groups are forwarded, and wherein each of the datagrams that belongs to a certain group is forwarded at a rate which is substantially identical to the rate at which all other datagrams that belong to that certain group are forwarded; and

if a determination is made by at least one first processor associated with the at least one transceiver that a change should be affected in a rate of forwarding another group of datagrams towards at least one second transceiver, forwarding all datagrams that belong to that other group of datagrams at a rate different from the rate at which datagrams that belong to a preceding group were forwarded to the at least one second transceiver;

at least one second transceiver, configured to receive the arriving datagrams;

at least one first processor associated with the at least one first transceiver and configured to:
include in each of the datagrams that belong to a group of datagrams, a first indication to enable identifying the group to which a respective datagram belongs;
based on the rate at which the datagrams were received at the at least one second transceiver, determine whether another group of datagrams that should be forwarded towards the at least one second transceiver, will be forwarded at a rate different from a rate at which a preceding group was forwarded to the at least one second transceiver; and

at least one second processor associated with the at least one second transceiver and configured to determine an arrival rate of datagrams (or equivalently, the number of arriving or non-arriving datagrams that belong to a certain group) which are received by the at least one second transceiver and belong to a certain group of datagrams, based on the respective first indication included in each of the arriving datagrams.

According to another embodiment of this aspect, the at least one second transceiver is further configured to forward a second indication towards the at least one first transceiver, wherein the second indication relates to a rate at which the datagrams have arrived thereat.

By yet another embodiment, the at least one second processor and the at least one second transceiver are further configured to forward a second indication towards the at least one first transceiver, at every pre-determined period of time.

In accordance with another embodiment, the at least one first processor is further adapted to determine whether the other group of datagrams will be forwarded at a rate different from a rate at which a preceding group was forwarded to the at least one second transceiver is based upon a QoS level guaranteed for forwarding of these datagrams from the at least one first transceiver to the at least one second transceiver.

By yet another embodiment, the determination made by the at least one first processor on whether to affect a change in the forwarding rate is made based upon whether the arrival rate of datagrams comprised in a certain group of datagrams, is lower than a threshold rate that was defined for that certain group of datagrams.

According to still another embodiment, the at least one first processor is further configured to evaluate an actual error rate E_{R, j} associated with a certain group (group j) of datagrams that were received by the at least one second transceiver. Preferably, based on this evaluation, the at least one first processor is further adapted to change dynamically the threshold rate based on the evaluated actual error rate.

In accordance with a third aspect, there is provided a non-transitory computer-readable storage media storing one or more sequences of instructions which when loaded and executed by a computer system cause one or more processors to perform a process for controlling transmission rate of datagrams in a packet-switched network, wherein that process comprises:

enable forwarding a plurality of datagram groups wherein each of the datagram groups includes a plurality of datagrams that comprise a first indication to enable identifying the group to which a respective datagram belongs, wherein forwarding of each of the plurality of groups is enabled at a time different from the time at which all other groups are forwarded, and wherein each of the datagrams that belong to a certain group is forwarded at a rate which is substantially identical to the rate at which all other datagrams that belong to that certain group will be forwarded;

upon receiving information that relates to an arrival rate at which datagrams that belong to a first group of datagrams were received at a different location, determine whether a change should be affected at the rate at which datagrams that belong to a second group of datagrams should be forwarded; and

if the determination is made that a change should be affected at the forwarding rate of datagrams that belong to the second group of datagrams, enable forwarding the second group of datagrams at a rate different from the rate at which the first group of datagrams was forwarded.

According to another embodiment, at least one parameter used in determining whether a change should be affected at the rate at which datagrams that belong to a second group of datagrams should be forwarded, is changed dynamically based upon information received regarding the reception of datagrams that belong to a preceding group of datagrams.

### BRIEF DESCRIPTION OF THE DRAWINGS

For a more complete understanding of the present invention, reference is made to the following detailed description taken in conjunction with the accompanying drawings wherein:

FIG. 1—illustrates a schematic overview of an embodiment of a system of the present invention; and

FIG. 2—is a flow chart demonstrating an embodiment of a method carried out in accordance with the present invention.

### DETAILED DESCRIPTION

The principles and operation of the method and system according to the present invention may be better understood with reference to the accompanying drawings and the following description that illustrate some specific non-limiting examples of preferred embodiments.

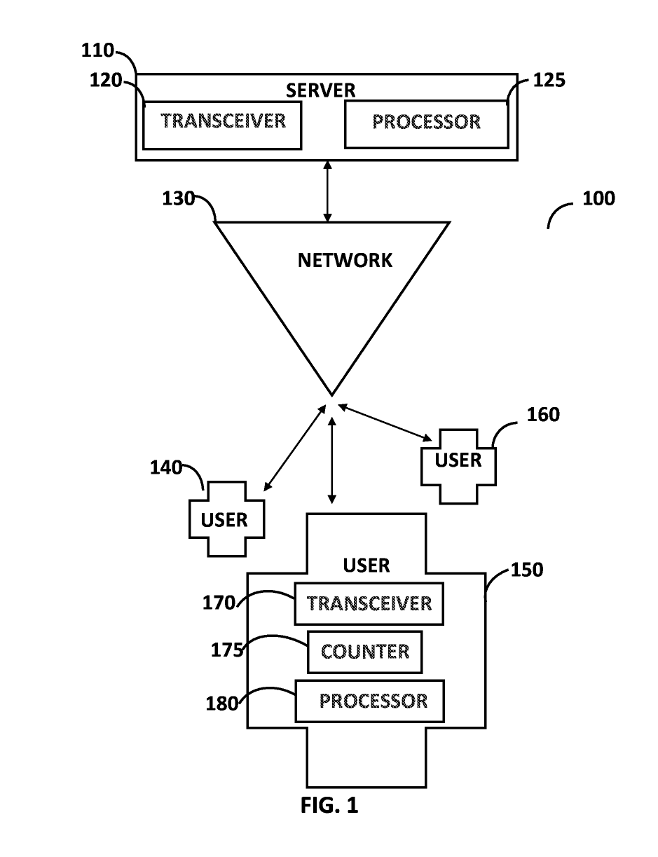

FIG. 1 illustrates an exemplified system in accordance with an embodiment of the present invention, for setting (optimizing) the rate of forwarding datagrams that are about to be conveyed in a packet-switched network. In other words, one of the goals of the system illustrated in this FIG. is to establish a minimal transmission rate at the server side in order to optimize (maximize) the effective packets' receiving rate at the client side. The traffic may be conveyed in conjunction with any applicable error correction mechanism (ARQ, FEC) in order to minimize errors or to guarantee error free delivery.

Preferably, the system aims to enable transmission of packets at a minimal packets' forwarding rate which would maximize the packets' receiving rate, subject to a QoS criterion. The QoS criterion typically defines at which percentage of lost packets the system will interpret such a packets loss as being congestion.

To further improve applicability to other types of traffic, the system may also implement secondary congestion detection mechanisms based on timing measurements such as jitter or round-trip time.

System 100 comprises one or more servers 110, each comprising at least one transceiver 120 and at least one processor 125, a network 130 (e.g. a packet switched network), and a plurality of client terminals 140-160. The network enables conveying packetized communications between server(s) 110 and client terminals 140-160. Although this example is demonstrated for conveying packets between the server 110 and client terminals, it should be appreciated that there are many other options of carrying out the invention between different entities belonging to the network, e.g. between gateways.

It should be noted that throughout the specification and claims there is made use of the verbs “to forward” and “to transmit” and “to convey” (in their different forms) with respect to the datagrams being communicated from one location to another location. All these verbs should be understood to be interchangeable, and denote the fact that the communication of the datagrams can either be done from a device which generate them at their present form and use transmission means to communicate them towards the other location, or such communication of datagrams can be done from a device that receives the datagrams and simply forward them further towards the other location.

Transceiver 120 is configured to forward datagrams arranged in a form of a plurality of datagram groups. Each datagram group includes a plurality of datagrams, where each of these datagrams comprises a first indication to enable identifying the group to which it belongs, e.g. a group number, a combination of a session number and a group number, and the like. This can be done for example by processor 125 that allocates a few bits in each packet of flow control counter that will enable identifying the group to which the packet belongs. The number of bits used for the flow control should be enough to ensure that there will be no ambiguity in the groups' numbers of the received packets.

After preparing the first group of packets (e.g. group j), where each packet is marked properly with the group identification (e.g. group number), the packets of group j are then conveyed from server 110 by transceiver 120 via network 130 to client 150. All the packets that belong to this group j are transmitted from transceiver 120 essentially at the same transmission rate F_{R, j}. After passing through network 130, the packets arrive to transceiver 170 of client 150. Transceiver 170 receives the arriving packets and counter 175 is operative to count the number of packets which, according to information comprised in the first indication, belong to the group j. As will be appreciated by those skilled in the art, typically packets that arrive to client 150 within a relatively short period of time, may belong to more than one group of packets (e.g. not only to group j of packets referred to above) so counter 175 should be able to differentiate between packets that belong to that specific group of interest (group j) and other packets. Once the number of packets that belong to group j and reached transceiver 170 within a pre-determined period of time, N_{R, j}, has been established, processor 180 receives that information and generates a message (a second indication) that will be forwarded to transceiver 120. This message indicates to processor 125 the rate R_{R, j} at which the N_{R, j} datagrams that belong to group j, have been received by transceiver 160. Optionally, the arrival rate for the packets of group j is reported every pre-determined period of time. Obviously, each such report may comprise information that relates not only to one group but to a number of groups, in case that packets belonging to different groups arrive to client 150 within a pre-determined period of time (e.g. a period extending between two consecutive reports).

Based on the information comprised in the second indication message, processor 125 determines whether the forwarding rate F_{R, j+1} at which the next group of datagrams, group j+1, i.e. the next group of packets that are due for transmission to client 150, should be forwarded at a different from the rate F_{R, j} at which the packets of group j were forwarded from transceiver 120, or not. To do so, processor 180 preferably checks whether the arrival rate R_{R, j} of packets that belong to group j, exceeds a corresponding threshold value Tⱼ that has been determined for group j and then evaluates the actual error rate E_{R, j} of group j, where the error rate may be calculated for example according to the ratio of forwarding and receiving rates (F_{R, j} to R_{R, j}), and/or based on missing sequence numbers as detected by client 150.

If the receiving rate R_{R, j} is below the respective threshold or if actual error rate E_{R, j} is above the error rate allowed for the QoS level by which these packets are expected to be conveyed to client 150, the value for E_{R, j+1} is set to be equal to the maximum allowable error rate for that QoS, processor 120 is now responsible to have the forwarding rate of group j+1, F_{R, J+1}, reduced in order to meet the above condition, i.e. the following relationship should be respected: F_{R, J+1}<F_{R, J}. The value of F_{R, J-1} may be determined by applying various reduction mechanisms. One such example is setting F_{R, j+1}=min(R_{R, j}*(1+E_{R, j}), F_{R, j}*−ε), where the error rate E_{R, j} is one that was calculated for the last group, for which a decision was taken to increase the forwarding rate. Where j* stands either group j, or for a preceding group which was the last group (before group j), for which the forwarding rate was increased, and ε denotes a small value by which that last forwarding rate will be reduced.

However, if the receiving rate R_{R, j} is above the respective threshold the value for F_{R, j+1} is set to be greater than F_{R, j}, and the respective threshold value for group j+1, Tⱼ₊₁, may be set for example to be equal to (1−E_{R, j})*F_{R, j+1}. This value might still be modified if for example congestion conditions have been developed in the network which the packets of j+1 group will encounter.

Following the determination made by processor 125 as set forth above, transceiver 120 will forward the packets of group j+1 at the determined rate F_{R, j+1}.

As an example, the following rules of thumb may be applied while controlling the rate of transmission of datagrams in accordance with the method embodiments of the present invention:
Rate may be increased if packet loss rate is below a threshold value (parameter);
Rate may be increased if round-trip delay (“RTT”) and jitter are below a threshold value;
Rate may be increased if the forwarding rate was increased for the last group, and the throughput reported for that group has increased;
At first, the forwarding rate is increased slowly by small steps (e.g. 1% of the traffic), and then if the increasing attempts of the forwarding rate turned out to be successful, the following steps for increasing the forwarding rate may be enlarged on an exponential scale;
Steps are reset in response to detecting unsuccessful attempts in increasing the forwarding rate;
Forwarding rate should not be increased if the recovery of retransmissions takes too long (this may indicate a clogged pipe);
When deciding to decrease the forwarding rate—the new forwarding rate which may be chosen is substantially equal to the receiving rate reported from the client side for the last group;
If no feedback (e.g. the second indication) is received from the client—the forwarding rate should be decreased; and
No new data should be sent from the first location, beyond the last in-sequence reported packet plus N packets, where N is a pre-defined number of packets.

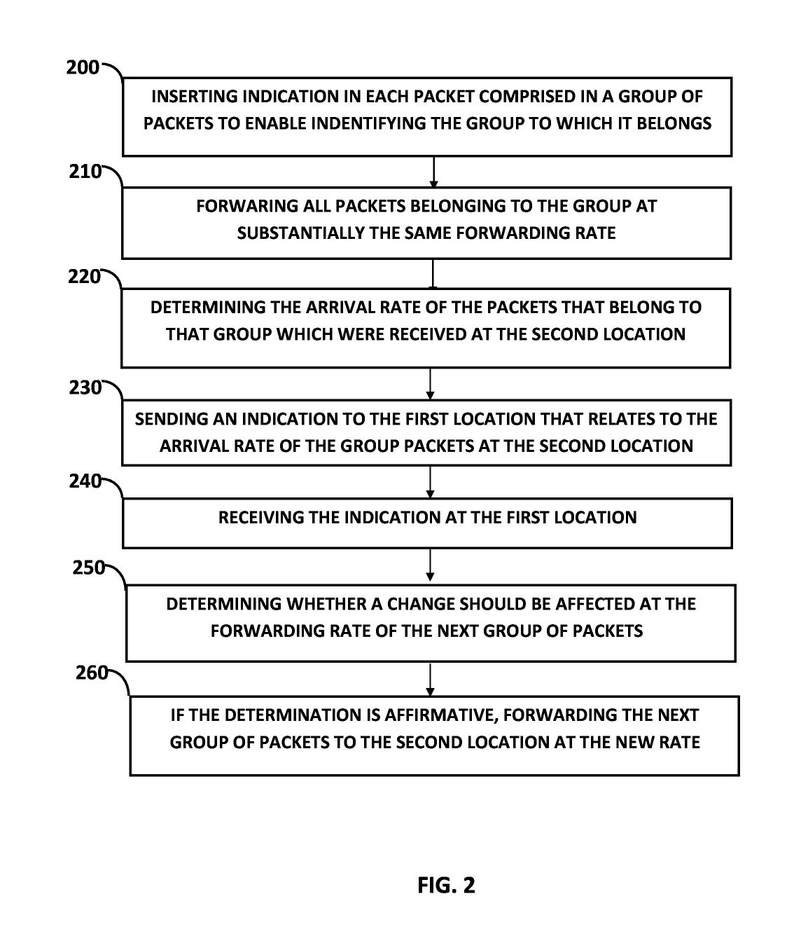

FIG. 2 demonstrates a flow chart of a method of carrying out an embodiment of the present invention for maximizing an effective transmission rate of datagrams (i.e. packets) to be communicated from a first location to a second location over a packet-switched network, in the system described in FIG. 1.

In this example, a group of datagrams is about to be sent from server 110 to client 150. However, before sending these datagrams, a group number is included in each of the datagrams (step 200) indicating that each of these datagrams belongs to the very same group. The datagrams of the group are then forwarded from server 110 (step 210) at a rate which is substantially identical for all the datagrams that belonging to that certain group.

Client 150 determines the arrival rate of these datagrams (step 220), and following this determination, an indication is sent to server 110 (step 230) which comprises information that relates to the arrival rate of datagrams that belong to that group, as determined in step 220.

Upon receiving at server 110 (step 240) the indication sent in step 230, the information that relates to the arrival rate of the datagrams belonging to that group of datagrams is retrieved, and based on this information, it is determined (step 250) whether a change should be affected to the rate at which datagrams that belong to another group of datagrams will be forwarded from server 110 to client 150. If the determination is that a change should be affected at the forwarding rate of the next group of datagrams, this next group of datagrams will be forwarded to client 150 at the new forwarding rate (step 260).

It should be understood that features described with respect to one embodiment may be used with other embodiments and that not all embodiments of the invention have all of the features shown in a particular figure. Variations of embodiments described will occur to persons of the art. For example, although that one of the steps described in the method provided comprises determining an arrival rate of datagrams which belong to a first group, still any other equivalent method which is known in the art per se to provide proportional results to the datagrams arrival rate, such as determining effective error rate, determining rate of packet loss etc., may be used. Also, although it was explained in the specification that the QoS level is associated with a percentage of datagrams that have timely arrived to the second location, still any other applicable definition of QoS may used. Furthermore, the determination of whether a change in the forwarding rate of the next group of datagrams has been described and claimed as a determination that is taken at the first location, however it should be clear to any person of the art that under certain conditions that decision may be taken at the second location (preferably, if the second location was made aware of the required QoS for these datagrams), and the second indication may then comprise information simply to enable the transceiver at the first location to change the transmission rate for transmitting the next group of datagrams when necessary, by informing that transceiver what should be the new transmission rate (or by how much should the old transmission rate be changed). Also, the examples provided in the detailed description section relate primarily to the transmission of datagrams from a server to a client terminal. However, it should be noted that the present invention is not limited to be carried out between such two entities, and its scope should be understood to include any other entities for which the method described herein may be applicable.

Furthermore, the terms “comprise,” “include,” “have” and their conjugates, shall mean, when used in the claims, “including but not necessarily limited to.” The scope of the invention is limited only by the following claims.

1. A method for controlling transmission rate of datagrams in a packet-switched network from a first location to a second location, wherein said method comprises the following steps:
forwarding a plurality of datagram groups from the first location towards the second location, wherein each of the datagram groups includes a plurality of datagrams that comprise a first indication to enable identifying the group to which each respective datagram belongs, wherein each of the plurality of groups is forwarded at a time different from the time at which all other groups are forwarded, and wherein each of the datagrams that belong to a certain group is forwarded from the first location towards the second location at a rate which is substantially identical to the rate at which all other datagrams that belong to that certain group will be forwarded from the first location towards the second location;
determining an arrival rate of datagrams which belong to a first group;
based on the determined arrival rate, determining whether a change should be affected at the rate at which datagrams that belong to a second group of datagrams will be forwarded towards the second location; and
if the determination is that a change should be affected at the forwarding rate of datagrams that belong to the second group of datagrams, forwarding the second group of datagrams at a rate different from the rate at which the first group of datagrams was forwarded from the first location.

2. The method of claim 1, wherein the step of determining whether a change should be affected at the forwarding rate of the second group of datagrams is based upon generating a second indication which comprises information that relates to the arrival rate of datagrams belonging to the first group of datagrams, and wherein said second indication is generated at every pre-determined period of time.

3. The method of claim 1, the determination on whether to affect a change in the forwarding rate is based upon a Quality of Service level guaranteed for forwarding datagrams from the first location towards the second location.

4. The method of claim 1, wherein the determination on whether to affect a change in the forwarding rate is made based on whether the arrival rate of datagrams that belong to a certain group of datagrams, is lower than a threshold rate that was defined for that certain group of datagrams.

5. The method of claim 1, further comprising a step of evaluating an actual error rate associated with a certain group of datagrams that are received at the second location.

6. The method of claim 5, wherein in case that it has been determined that a change should be affected at the rate at which datagrams that belong to a second group of datagrams will be forwarded towards the second location, the rate is decreased so that the error rate associated with a proceeding group of datagrams upon their arrival to the second location, would be equal to or less than the maximum allowable error rate according to a Quality of Service level defined for forwarding these datagrams.

7. The method of claim 4, wherein if the arrival rate of datagrams that belong to a certain group of datagrams that were forwarded from the first location is equal to or higher than a threshold rate that was defined for that certain group of datagrams, the method further comprises a step of increasing the forwarding rate for a proceeding group and setting a new threshold for the arrival of the proceeding group of datagrams.

8. The method of claim 1, wherein the datagrams carry multimedia streams.

9. A system for controlling transmission rate of datagrams in a packet-switched network, wherein the system comprises:
at least one first transceiver
configured to forward a plurality of datagram groups, wherein each of the datagram groups includes a plurality of datagrams that comprise a first indication to enable identifying the group to which a respective datagram belongs, wherein each of the plurality of groups is forwarded at a time different from the time at which all other groups are forwarded, and wherein each of the datagrams that belongs to a certain group is forwarded at a rate which is substantially identical to the rate at which all other datagrams that belong to that certain group are forwarded; and
if a determination made by at least one first processor associated with the at least one transceiver is, that a change should be affected in a rate of forwarding another group of datagrams towards at least one second transceiver, forwarding all datagrams that belong to that other group of datagrams at a rate different from the rate at which datagrams that belong to a preceding group were forwarded to the at least one second transceiver;
at least one second transceiver, adapted to receive the arriving datagrams;
at least one first processor associated with the at least one first transceiver and adapted to:
include in each of the datagrams that belong to a group of datagrams, a first indication to enable identifying the group to which a respective datagram belongs;
based on the arrival rate of datagrams that belong to said group of datagrams at the second location, determine whether another group of datagrams that should be forwarded towards the at least one second transceiver, will be forwarded at a rate different from a rate at which said group was forwarded to the at least one second transceiver; and
at least one second processor associated with the at least one second transceiver and adapted to determine an arrival rate of datagrams which are received by the at least one second transceiver and belong to a certain group of datagrams, based on the respective first indication included in each of the arriving datagrams.

10. The system of claim 9, wherein the at least one second processor and the at least one second transceiver are further configured to forward at every pre-determined period of time, a second indication towards the at least one first transceiver wherein said second indication comprises information that relates to the arrival rate of datagrams that belong to a group of datagrams.

11. The system of claim 9, wherein the determination made by the at least one first processor on whether to affect a change in the forwarding rate is made based upon whether the arrival rate of datagrams included in a certain group of datagrams, is lower than a threshold rate that was defined for said certain group of datagrams.

12. The system of claim 9, wherein the at least one first processor is further configured to evaluate an actual error rate associated with a certain group of datagrams that were received by the at least one second transceiver and based upon said evaluation, the at least one first processor is further configured to change dynamically the threshold rate based on the evaluated actual error rate.

13. A non-transitory computer-readable storage media storing one or more sequences of instructions which when loaded and executed by a computer system cause one or more processors to perform a process for controlling transmission rate of datagrams in a packet-switched network, wherein said process comprises:
enable forwarding a plurality of datagram groups wherein each of the datagram groups includes a plurality of datagrams which comprise a first indication that enables identifying the group to which a respective datagram belongs, wherein forwarding of each of the plurality of groups is enabled at a time different from the time at which all other groups are forwarded, and wherein each of the datagrams that belong to a certain group is forwarded at a rate which is substantially identical to the rate at which all other datagrams that belong to that certain group will be forwarded;
based on received information that relates to an arrival rate at which datagrams that belong to a first group of datagrams were received at a different location, determine whether a change should be affected at the rate at which datagrams that belong to a second group of datagrams should be forwarded; and
if the determination is made that a change should be affected at the forwarding rate of datagrams that belong to the second group of datagrams, enable forwarding of the second group of datagrams at a rate different from the rate at which the first group of datagrams was forwarded.

14. The non-transitory computer-readable storage media of claim 13, wherein at least one parameter used in determining whether a change should be affected at the rate at which datagrams that belong to a second group of datagrams should be forwarded, is changed dynamically based upon information received regarding the reception of datagrams that belong to a preceding group of datagrams.
